(19) United States
(12) Patent Application Publication
(10) Pub. No.: US 2004/0264325 A1
(43) Pub. Date: Dec. 30, 2004

(54) Optical disk apparatus and information recording apparatus

(75) Inventors: Akio Fukushima, Yokohama (JP); Masayoshi Okawa, Kokubunji (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Renesas Technology Corp., Tokyo (JP)

(21) Appl. No.: 10/877,491

(22) Filed: Jun. 24, 2004

(30) Foreign Application Priority Data
Jun. 26, 2003 (JP) 2003-181941

(51) Int. Cl. G11B 5/09

(52) U.S. Cl. 369/47.27; 369/47.54; 369/47.31; 369/47.21

(57) ABSTRACT

The present invention provides a technology for increasing the recording system clock speed for high-speed information recording onto an optical disk or the like without sacrificing the frequency resolution. A necessary recording system clock frequency is calculated from address information that is modulated by a wobble signal and recorded. A crystal oscillator or other stable reference signal source generates a signal having the calculated frequency by a synthesizing method. The generated signal is used as a recording system clock.

### CLAIM OF PRIORITY

The present application claims priority from Japanese application serial.no. P2003-181941, filed on Jun. 26, 2003, the content of which is hereby incorporated by reference into this application.

### BACKGROUND OF THE INVENTION

1. Field of the Invention

The present invention relates to an information recording apparatus that is capable of recording information on an information recording medium.

2. Description of the Related Art

In a conventional optical disk apparatus for recording information on a CD-R, CD-RW, DVD-R, DVD-RW, or other recordable optical disk, the rotating speed of a spindle motor for rotating the optical disk is controlled so that the linear velocity at which an optical spot for optically recording information scans groove-shaped tracks formed on the optical disk is substantially constant (constant linear velocity (hereinafter referred to as CLV)). The reason is that the upper-limit linear density should be constantly used for recording in order to make effective use of the available amount of information recording on the disk because the amount of information recordable on the′ disk is proportional to the recording linear density. In recent years, however, some optical disk recording apparatuses have begun to provide rotation control to ensure that the angular velocity of the optical disk is substantially constant (constant angular velocity (hereinafter referred to as CAV)). Changing the disk rotation speed for recording from CLV to CAV provides various advantages. For example, it is not necessary to wait for the rotation speed to be settled because the disk rotation speed need not be changed even when the recording position (radial position) on the disk is changed. In addition, the power consumption does not increase due to acceleration/deceleration for a rotation speed change.

For recording in the CAV mode, the linear velocity varies with the radius of a recording position on the disk. To keep the recording linear density constant while the linear velocity varies, it is therefore necessary to vary the data recording rate during a recording process. Consequently, an encoder circuit for generating recording data and a recording strategy circuit for determining the timing of laser radiation, which is necessary for recording, need to change their operating speed during recording in accordance with a change in the data recording rate. Under such circumstances, the clock signal (hereinafter referred to as the recording system clock), which serves as the reference for the above circuits, needs to be variable.

A conventionally used CLV recording method will now be described prior to explanation of a CAV recording technology. First of all, a wobble signal will be described. On the aforementioned recordable optical disk, a wobble is formed by causing a track to meander slightly in radial direction. The wobble can be detected from a tracking error signal. When a signal is extracted from the tracking error signal, it is called a wobble signal. The characteristics of the wobble signal will now be described using a CD-R as an example. The characteristics of the wobble signal include:

(1) The wobble signal frequency is substantially constant while the disk rotates in the CLV mode (the average frequency of the wobble signal is hereinafter referred to as the wobble frequency).

(2) The wobble frequency is frequency-modulated to record address information.

(3) For the above recorded address information, a CRC (cyclic redundancy code) based error detection technology is used to achieve error detection.

A method for recording onto a CD-R disk with a wobble signal will now be described. For recording in the CLV mode, it is necessary to first rotate the disk in the CLV mode. For that purpose, the spindle motor rotation speed is controlled using characteristic (1) above so that the wobble frequency is substantially constant. In a first method, the frequencies and/or phases of a reference frequency signal and wobble signal are compared, and the spindle motor rotation speed is controlled so as to minimize the frequency/phase difference. If the reference frequency signal is fixed, the wobble frequency is substantially constant so that the disk rotates in the CLV mode. While the disk rotates in the CLV mode, the linear velocity is constant. Therefore, the recording system clock should have a constant frequency in order to ensure that the data recording density is constant.

In a second method, characteristic (2) above is used. In other words, the second method may be used to detect a difference between first address information, which is prerecorded on the disk in such a manner that it is superposed over the wobble signal, and second address information, which is contained in the data to be recorded onto the disk, and control the spindle motor rotation speed so that the difference is less than specified value. More specifically, a clock having a constant frequency is employed as the recording system clock to detect the frequency difference and/or phase difference between the first address information, which is superposed over the wobble signal for recording purposes, and the second address information, which is generated from the recording system clock, and control the spindle motor rotation speed to ensure that the frequency difference/phase difference is not greater than the specified value.

In both of the above two methods, the recording system clock has a constant frequency and the rotation of the disk is controlled in the CLV mode. Therefore, CLV recording takes place. CLV recording is accomplished by controlling the spindle motor and recording system clock in a manner described above.

A CAV recording method will now be described. For recording in the CAV mode, it is necessary to control encoding clock generation means and spindle motor as described below.

In a first method for controlling the encoding clock generation means and spindle motor, the spindle motor rotation speed is detected by an FG or other device mounted on the spindle motor and subjected to feedback control so as to reduce the difference between the FG output signal frequency and reference signal frequency. Control is further exercised to obtain a specified spindle motor rotation speed. The encoding clock is generated by multiplying the wobble signal frequency with a frequency synthesizer, which uses the wobble signal detected from the disk as the reference frequency. Further, the difference (address difference) between the first address information, which is prerecorded on the disk, and the second address information, which is contained in the data to be recorded on the disk, is detected, and the encoding clock frequency is controlled so that the address difference is not greater than specified.

A method for controlling the encoding clock frequency will now be described in detail. Encoding clock frequency control can be exercised, for instance, by varying the frequency synthesizer multiplication ratio in accordance with the polarity (plus or minus) and magnitude of the address difference. If the first address information is greater than the second address information, the wobble-recorded address on the disk is ahead of the address contained in the data to be recorded. Therefore, the second address progress speed, that is, the data recording rate, is increased to catch up with the progress of the first address.

In a second method, the spindle motor rotation speed is detected by an FG or other device mounted on the spindle motor, and feedback control is exercised to reduce the difference between the FG output signal frequency and reference signal frequency. Control is further exercised to obtain a specified spindle motor rotation speed. The encoding clock is generated by multiplying with a frequency synthesizer, which uses the wobble signal detected from the disk as the reference frequency. Further, the difference (address difference) between the first address information, which is prerecorded on the disk, and the second address information, which is contained in the data to be recorded on the disk, is detected, and the encoding clock frequency is controlled so that the address difference is not greater than specified. More specifically, encoding clock frequency control can be exercised by adding the address difference to the frequency/phase difference of the frequency synthesizer.

In a third method, the data recording rate for an address is calculated from the address and other information detected from the disk. The encoding clock target frequency for attaining the calculated data recording rate is then calculated. Further, the encoding clock frequency is generated from the reference signal frequency which is a specific frequency by using a frequency synthesizer or like device so that the target frequency of the encoding clock is obtained. The spindle motor rotation speed is detected by an FG or other device mounted on the spindle motor. Feedback control is exercised so as to reduce the difference between the FG output signal frequency and FG reference signal frequency (rotation speed difference), and then control is exercised to obtain a specified spindle motor rotation speed. Further, the address difference between the prerecorded address information that is superposed over the wobble signal and recorded on the disk and the address information contained in the data to be recorded on the disk address difference is detected. The spindle motor drive signal is then controlled by adding the address difference to the above rotation speed difference so that a specified difference (address difference) is obtained.

In a fourth method, the target encoding clock frequency is calculated from address and other information detected from the disk, and generated from the reference signal frequency which is a specific frequency by using a frequency synthesizer or like device. The spindle motor rotation speed is detected with an FG or other device mounted on the spindle motor. Feedback control is exercised so that the ratio between the FG output signal frequency and FG reference signal frequency is as specified. Control is further exercised so as to obtain a specified spindle motor rotation speed. Moreover, the difference between the prerecorded address information that is superposed over the wobble signal and recorded on the disk and the address information to be recorded on the disk is detected. The spindle motor drive signal is then controlled by adjusting the ratio between the FG output signal frequency and FG reference signal frequency so that a specified difference (address difference) is obtained.

When one of the methods described above is used, it is possible to achieve CAV recording because the encoding clock frequency is proportional to the recording radial position while the recording linear density is substantially kept constant.

In reality, however, when the above first method is used for CAV recording, a carrier signal is extracted from the wobble signal, which is reproduced from the disk via a pickup, and a PLL circuit or other clock generation system generates a recording system clock in accordance with the extracted carrier signal. Therefore, the recording system clock is affected, for instance, by the disk, pickup, spindle motor control system for disk rotation, wobble signal reproduction system, carrier signal extraction system, and clock generation system. As a result, it is necessary to devise a scheme for improving the wobble signal reproduction quality (as indicated, for instance, in Patent Document 1).

When the above second, third, or fourth method is used for CAV recording, the address information is extracted from the wobble signal, which is reproduced from the disk via the pickup, and then the recording rate is calculated from the extracted address information. Further, a recording system clock is generated with a frequency synthesizer so that the encoding clock frequency corresponds to the calculated recording rate. Therefore, the recording system clock is affected, as mentioned above, by the disk, pickup, spindle motor control system for disk rotation, address demodulation system, and the like. In any case, it is necessary to continuously vary the recording system clock frequency, which is generated by the frequency synthesizer, in accordance with a continuous change in the disk's information recording radial position.

[Patent Document 1]

Japanese Patent Laid-open No. Hei 11-306686

### SUMMARY OF THE INVENTION

If the recording system clock jitter is significant, the recording mark edge fluctuation may increase during data recording on the disk, thereby causing an increase in the data error rate. To maintain adequate recording quality, it is therefore necessary to manage various elements related to recording system clock generation. The elements related to recording system clock generation for CAV recording include the disk, pickup, spindle motor control system for disk rotation, wobble signal reproduction system, carrier signal extraction system, and clock generation system.

The influence of the elements upon recording system clock quality during the use of a conventional technology will now be described.

Relatively speaking, the disk quality significantly varies from one disk to another. For example, some marketed disks may fail to comply with their requirements in terms, for instance, of wobble groove forming accuracy and wobble meandering cycle accuracy. The pickup needs to be mechanically accurate during its assembly. In reality, therefore, the pickup tends to significantly vary from one unit to another. The control method for the spindle motor control system varies depending on whether the disk rotates in the CAV mode or in the CLV mode. However, both modes use the FG signal and reference frequency signal for control purposes as described earlier. Therefore, the spindle motor control system is rarely influenced by an undetermined extraneous factor and relatively stable without exhibiting significant variations.

The wobble signal reproduction system comprises an optical pickup push-pull signal detection system and a front-end signal processing circuit. As described above, the optical pickup related section significantly varies from unit to another. Further, the pickup's optical configuration may occasionally be incompatible with the employed disk. The front-end signal processing circuit rarely causes a problem because it is generally formed as an internal circuit for an LSI. For wobble signal reproduction, a sample-and-hold process is performed. More specifically, the wobble signal is sampled for detection the moment the amount of laser emission for data recording is equal to that for reproduction. Under such circumstances, the signal-to-noise ratio is likely to deteriorate due, for instance, to switching noise generated from a sample-and-hold processing circuit and excessive signal input for recording, which is caused by improper sample-and-hold timing.

The carrier signal extraction system is configured so that a carrier signal, which is one of the signals contained in the wobble signal, is extracted with a bandpass filter. In CAV recording, the longer the radial distance of the recording position, the higher the linear velocity. The carrier frequency increases with an increase in the linear velocity. Therefore, the carrier signal extraction system needs to detect the frequency of the carrier signal, follow carrier signal frequency changes in accordance with the detected carrier signal, and vary the center frequency of the bandpass filter. As regards the bandpass filter for carrier extraction, a relatively high Q value setting is frequently employed. Therefore, when the carrier frequency deviates from the bandpass filter center frequency, the carrier signal carrier-to-noise (C/N) ratio readily changes. Thus, it is necessary to perform setup so that the bandpass filter center frequency does not deviate from the carrier signal frequency.

The clock generation system is a circuit for generating a recording system clock having a frequency that is in a specific ratio to the frequency of an input wobble signal. It is usually configured so that the wobble signal frequency is multiplied by a circuit known as a PLL circuit. Owing to the limitations imposed by the structure of the PLL circuit, the amount of carrier signal jitter may increase, thereby increasing the amount of jitter in the recording system clock, which is a PLL output signal, if the input wobble signal quality is poor and the carrier signal contains a considerable amount of noise. Even if the wobble signal quality is satisfactory, recording system clock jitter control cannot easily be exercised due, for instance, to design limitations. More specifically, the reason is that the carrier signal frequency varies with time as the CD-R wobble signal is frequency-modulated, and that the PLL must cover a relatively large frequency range as the carrier frequency ratio between the innermost and outermost tracks is approximately 2.5.

When the conventional recording system clock generation technology is used, it is difficult to constantly maintain a satisfactory recording system clock quality during CAV recording as described above. Therefore, it has been difficult to achieve CAV recording although CAV recording is superior to CLV recording in that the disk rotation speed does not vary during recording.

Therefore, when the conventional technology is used with a view toward maintaining a satisfactory recording system clock quality during CAV recording, the recording system clock frequency is generated from a crystal oscillator or other stable frequency signal source according to a method called “frequency synthesizing” instead of using the wobble signal as the reference for recording system clock generation. In this instance, the recording system clock frequency is output after being adjusted for a frequency close to a target recording system clock frequency, which is calculated from various information, including address information, disk track pitch, disk linear velocity, spindle motor rotation angular velocity, and recording target position on disk surface. Further, the recording system clock frequency, spindle motor rotation speed, and the like are adjusted so that the address difference between the address information prerecorded on the disk and the address information to be recorded as part of recording data does not exceed a specified value.

The above adjustments make it possible to maintain a satisfactory recording system clock quality for CAV recording and achieve better CAV recording results.

When CAV recording is performed as described above, the frequency resolution-of the recording system clock frequency varies with the frequency synthesizer configuration. The frequency synthesizer will now be described.

The frequency synthesizer generally comprises a reference signal source; a first frequency divider, which divides the frequency of a reference frequency signal (frequency f₀) generated from the reference signal source by M; a variable frequency signal source; a second frequency divider, which divides a variable frequency signal output (frequency f₁) from the variable frequency signal source by N; a frequency/phase detector, which compares the frequency difference/phase difference between the first frequency divider output and the second frequency divider output and outputs a signal according to the frequency difference/phase difference; and a low-pass filter for attenuating high-frequency components of a frequency/phase difference signal output from the frequency/phase detector. The signal output from the low-pass filter enters frequency control signal input of above mentioned variable frequency signal source.

When the frequency synthesizer is configured as described above, locking occurs if two input signals of the frequency/phase detector equal in frequency and phase, that is, the following equation is satisfied:

f₀/M=f₁/N (Equation 1)

In the above instance, the frequency f₁ is as follows:

f₁=f₀·N/M (Equation 2)

The above signal is output from the variable frequency signal source and used as the output of the frequency synthesizer.

The frequency resolution of the frequency synthesizer will now be described. When the resolution of a frequency that the frequency synthesizer can generate is Δf₁, the following equation is obtained:

Δf₁=f₁−f₁′=(f₀·N₀/M₀)−(f₀N₁/M₁)=f₀·(N₀/M₀−N₁/M₁) (Equation 3)

Therefore, the frequency resolution varies depending on the combination of N₀, N₁, M₀, and M₁. In the simplest case, that is, when MO=M₁ and N₀=N₁+1, the following equation is obtained:

Δf₁=f₀/M₀ (Equation 4)

Since f₁=f₀·N₀/M₀, the following equation is obtained:

Δf₁/f₁=1/N₀ (Equation 5)

Thus, if it is assumed as a general example that M₀=200 while N₀=100, the frequency resolution is 0.5% of f₀. When the value N₀ increases by 1, the frequency change rate is 1%.

When the frequency synthesizer is used for recording system clock generation, its output signal frequency f₁ varies with the disk type targeted for recording and the recording rate. However, it is common that the output signal frequency is an integer multiple of the prevailing channel bit clock frequency. If, for instance, CD recording is performed at a standard recording rate, the channel bit clock frequency f_{bck}=4.3218 MHz. For example, 8.6436 MHz and 17.2872 MHz are used as the value f₁ because they are obtained by multiplying the value f_{bck} by 2n (n=natural number).

The recording rate is now remarkably increased for information recording apparatuses for recording information onto CDs or DVDs. For example, CD recording is performed at 48 times the normal recording rate, and DVD recording is performed at 4 times the normal recording rate. In such situations, the value f₁ ranges from approximately 180 MHz to 400 MHz. If the recording rate further increases in the future, it is expected that the value f₁ will increase to approximately 1 GHz.

When the frequency synthesizer is configured, the maximum values for M and N are generally limited. The first reason is that if the values M and N are increased to increase the frequency division ratio, the scale of a counter for the frequency divider increases, making it difficult to operate the counter at a high speed. The second reason is that there is no alternative but to lower the cut-off frequency for the low-pass filter as the frequencies of the signals to be compared by the frequency/phase detector decrease. Consequently, the PLL system band lowers and settling time which is the time required for the output frequency to converge to a target value becomes longer.

In the above situation, although the value f₁ is expected to increase, it is difficult to increase the values M and N. On the contrary, the values M and N have to be decreased sooner or later. It is then anticipated that the frequency resolution will decrease in the future.

The frequency resolution required for CAV recording will now be described. First of all, the permissible level of frequency difference between the target recording system clock frequency and recording system clock frequency will be described. It is generally agreed that when an optical disk is mounted in a recording apparatus, the virtual center of the optical disk does not perfectly align with that of a turntable. The virtual center of the optical disk slightly deviates from that of the turntable. This deviation is herein referred to as eccentricity. In a disk retention mechanism of a normal recording apparatus, an eccentricity of approximately 100×10⁻⁶ m readily occurs. If such an eccentricity exists, the distance between an optical spot and turntable virtual center varies in the form of a sine wave during a revolution. Therefore, the linear velocity varies in the same manner even if the spindle motor rotation speed is constant. As a result, the recording system clock frequency also varies sinusoidally in accordance with the degree of eccentricity during a revolution. If, for instance, an eccentricity of ±100×10⁻⁶ m exists at a radius of 30×10⁻³ m, the radius varies from 29.9×10⁻³ m to 30.1×10⁻³ m. Therefore, the resulting recording system clock frequency change is (±100×10⁻⁶ m/30×10⁻³m)×100=±0.33%.

A spindle motor rotation speed change will now be described. As described earlier, CAV control is exercised so that the spindle motor rotates at a virtually fixed speed. However, when microscopically viewed, the spindle motor rotation speed varies. The reason for such a microscopic variation will now be described. A three-phase brushless motor is frequently employed as the spindle motor. As mentioned earlier, a hall element is used for magnetic pole detection. The hall element is required for each phase. Therefore, three hall elements are positioned in such a manner that the signals from the hall elements are 120 degrees out of phase with each other. The mounting positions of the hall elements are in mechanical error. Further, the three hall elements vary from each other in sensitivity. Furthermore, magnetized strength of the rotors made of a permanent magnet are varying. As a result, output signal of the hall elements have jitter. The jitter causes the rotation speed to vary during a single revolution. It is generally said that such rotation speed variation is approximately ±0.5%.

As is obvious from the foregoing description, the rotation speed variation is caused by the sum of eccentricity and motor-related factors. It should be assumed that the rotation speed variation is approximately 1%. This microscopic rotation speed variation cannot readily be suppressed by rotation speed control. It is estimated that the same degree of rotation speed variation occurs no matter whether CAV control or CLV control is exercised. In other words, although the above-mentioned degree of rotation speed variation occurs in a recording apparatus for conventional CLV recording, such rotation speed variation causes no practical problem.

The above estimation implies that the maximum permissible level of frequency difference between the target recording system clock frequency and recording system clock frequency is ±1%. Preferably, the permissible level of frequency difference should be approximately ±0.3%, which is equivalent to variation caused by eccentricity.

Therefore, the recording system clock frequency is set so that its difference from the target recording system clock frequency does not exceed ±1%. Consequently, the frequency resolution of a clock generation circuit should preferably be ±0.5% or less.

As described above, the achievable frequency resolution is approximately 1% when the currently available, frequency synthesizer is used for recording system clock generation. This achievable frequency resolution is equivalent to the required frequency resolution. Therefore, when a frequency resolution decrease, which will be caused by a future increase in the recording rate, is taken into account, the above-mentioned frequency resolution is considered to be inadequate.

It is an object of the present invention to provide a frequency synthesizer that prevents the frequency resolution from failing to meet the requirements and has an adequate frequency resolution even when the recording system clock speed increases due to an increase in the recording rate.

To achieve the above object, the present invention rapidly changes the selected value for setting the output frequency of the frequency synthesizer from among a plurality of different values so that the average output frequency of the frequency synthesizer is between frequencies determined by the plurality of different values, and controls the settings and the time ratios for controlling the settings so that the average output frequency coincides with a desired frequency.

More specifically, clock generation means for generating a recording system clock is capable of generating a clock signal having the following frequency (M and N are natural numbers) on the basis of a reference frequency signal source having a frequency of fₛ, by using a frequency synthesizer circuit, and in accordance with clock frequency setup information:

f₀=fₛ·(M/N) (Equation 6)

The value M above and its adjacent value M′ are then alternately selected. Further, M/M′ changeover timing control is exercised to vary the time ratio a for selecting the value M. Meanwhile, the value N above and its adjacent value N′ are alternately selected. Further, N/N′ changeover timing control is exercised to vary the time ratio β for selecting the value N. Thus, the frequency f₀ of the clock signal generated by the frequency synthesizer is as indicated below:

f₀=fₛ·{M·α+M′·(1−α)}/{N·β+N′·(1−β)} (Equation 7)

Then, the values M, M′, N, and N′ are appropriately selected in accordance with the clock frequency setup information. Further, the values α and β are also controlled to output a clock signal having the frequency f₀ that is close to a target frequency.

The clock signal having the frequency f₀ is handled as the output of the frequency synthesizer and used as the recording system clock signal for an optical disk apparatus.

### BRIEF DESCRIPTION OF THE DRAWINGS

FIG. 1 illustrates the configuration of a recording system signal processing circuit according to a first embodiment of the present invention.

FIG. 2 shows a major section of an optical disk apparatus that contains a recording system block according to the present invention.

FIG. 3 is a block diagram of a frequency synthesizer for a clock generation circuit.

FIG. 4 illustrates frequency divider setting changes according to the first embodiment of the present invention.

FIG. 5 illustrates frequency divider setting changes according to the first embodiment of the present invention.

FIG. 6 illustrates frequency divider setting changes according to the first embodiment of the present invention.

FIG. 7 illustrates frequency divider setting changes according to the first embodiment of the present invention.

FIG. 8 illustrates frequency divider setting changes according to the first embodiment of the present invention.

FIG. 9 illustrates the configuration of a recording system signal processing circuit according to a second embodiment of the present invention.

FIG. 10 illustrates the configuration of a recording system signal processing circuit according to a third embodiment of the present invention.

FIG. 11 illustrates the configuration of a recording system signal processing circuit according to a fourth embodiment of the present invention.

FIG. 12 illustrates the configuration of a recording system signal processing circuit according to a fifth embodiment of the present invention.

FIG. 13 illustrates the configuration of a recording system signal processing circuit according to a sixth embodiment of the present invention.

### DETAILED DESCRIPTION OF THE PREFERRED EMBODIMENTS

Embodiments of the present invention will now be described with reference to the accompanying drawings. It is assumed that the following embodiments relate to an optical disk apparatus for recording onto a CD-R disk. However, the present invention is not limited to an optical disk apparatus for recording onto a CD-R disk. The present invention can also be applied to an optical disk apparatus for recording onto a CD-RW, DVD-R, DVD-RW, DVD+RW, DVD+R, or other similar disk. Further, the present invention is also applicable to a general optical disk recording apparatus and a magnetic disk apparatus.

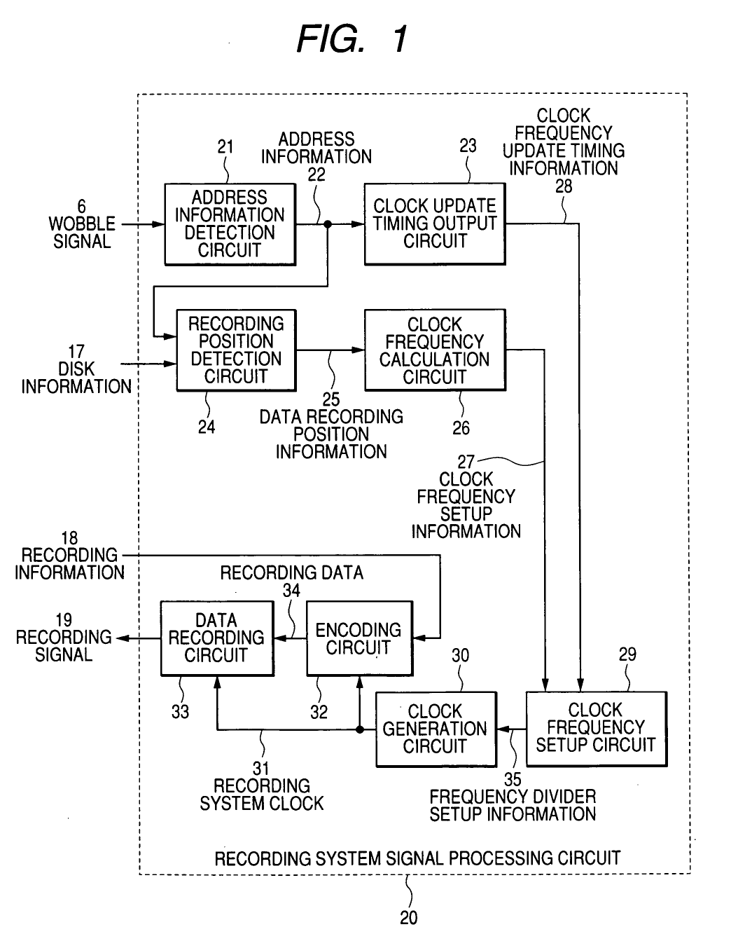

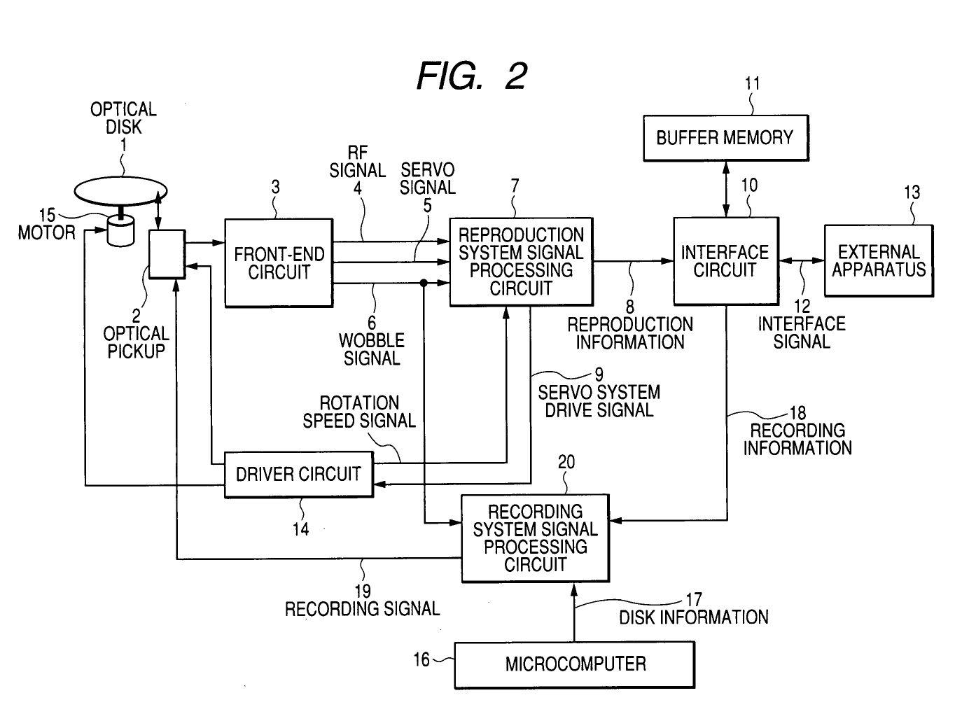

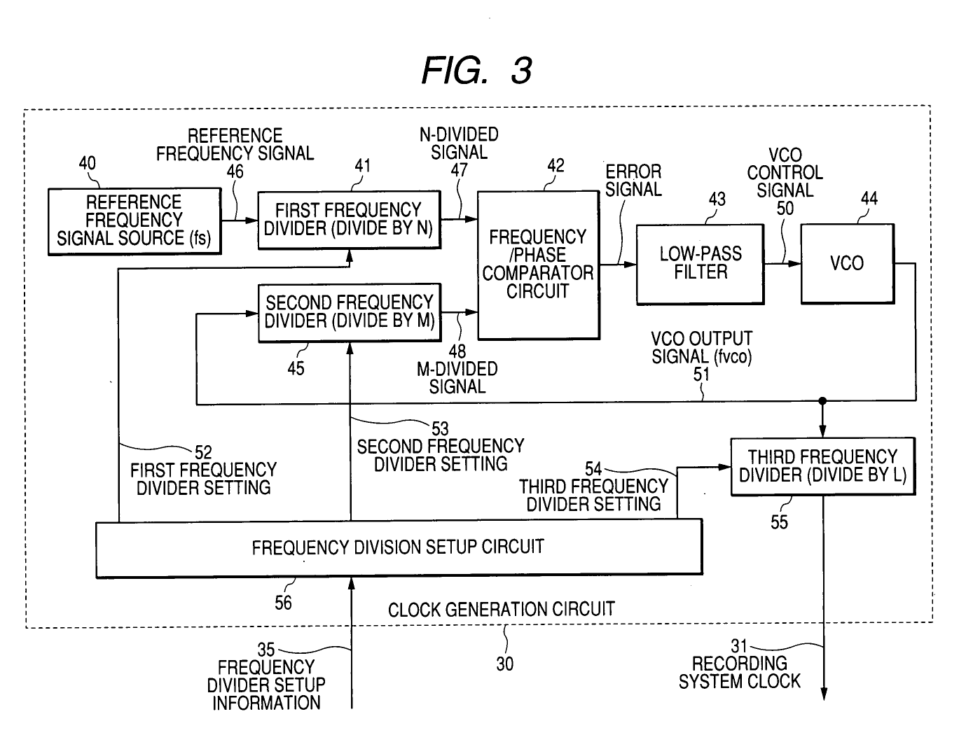

FIGS. 1, 2, and 3 illustrate a first embodiment of the present invention. FIG. 1 is a block diagram that relates to an optical disk recording apparatus, which is capable of recording onto a CD-R disk, and illustrates a data recording section according to the present invention. FIG. 2 is a block diagram illustrating a major section of the optical disk recording apparatus, which contains a recording system block that is shown in FIG. 1 in accordance with the present invention. FIG. 3 is a block diagram that illustrates a major section including a frequency synthesizer, which constitutes a clock generation circuit that is shown in FIG. 2 in accordance with the present invention.

A process for reproducing information from an optical disk will now be described with reference to FIG. 2. An optical pickup 2 detects a signal from an optical disk 1. The detected signal enters a front-end circuit 3. The front-end circuit 3 mainly performs an analog signal process to generate an RF signal 4, a servo signal 5, and the like. These signal output from the front-end circuit 3 enter a reproduction system signal processing circuit 7. The reproduction system signal processing circuit 7 mainly performs a digital signal process to generate reproduction information 8, a servo system drive signal 9, and the like. The reproduction information 8 enters an interface circuit 10. The interface circuit 10 performs, for instance, a data buffering process with a buffer memory 11, which is connected to the interface circuit 10, and outputs information to an external apparatus 13 through the use of an interface signal 12. Meanwhile, the servo drive signal 9 enters a driver circuit 14. The driver circuit 14 exercises, for instance, a power amplification function to drive an actuator (not shown) within the optical pickup 2, a motor (not shown) for moving the optical pickup assembly, and a motor 15 for rotating the optical disk 1. For information reproduction in an actual optical disk apparatus, various other circuits, including those for various servo systems, access system, RF signal demodulation system, error detection/correction system, and audio reproduction system, also operate in coordination with each other. However, these circuits are not described herein because they do not directly relate to the present invention.

A process for recording information onto the optical disk will now be described with reference to FIGS. 1 and 2. The optical pickup 2 detects a signal from the optical disk 1. The detected signal enters the front-end circuit 3. The front-end circuit 3 mainly performs an analog signal process to generate a servo signal 5, a wobble signal 6, and the like. These signal output from the front-end circuit 3 enter the reproduction system signal processing circuit 7. The reproduction system signal processing circuit 7 mainly performs a digital signal process to generate a servo system drive signal 9. The wobble signal 6 enters the recording system signal processing circuit 20.

The wobble signal 6 is fed into an address information detection circuit 21 within the recording system signal processing circuit 20. The address information detection circuit 21 demodulates address information (ATIP (Absolute Time In Pre-groove)) from the wobble signal 6 and outputs address information 22. The address information 22 enters a clock update timing output circuit 23 and a recording position detection circuit 24.

Meanwhile, a track pitch, which is measured and calculated by a microcomputer 16, linear velocity, recording start position radius, and other disk information 17 also enter the recording position detection circuit 24 within the recording system signal processing circuit 20. The recording position detection circuit 24 calculates data recording position information 25 from the disk information 17 and address information 22 and outputs the calculated information. The data recording position information 25 enters a clock frequency calculation circuit 26.

The clock frequency calculation circuit 26 performs calculations on the entered data recording position information 25 to determine the frequency of a recording system clock that corresponds to the data recording position information 25, and handles the calculated value as a target recording system clock frequency. Further, the clock frequency calculation circuit 26 outputs clock frequency setup information 27, which is required for using a clock frequency close to the target recording system clock frequency and conforming to specified conditions as a recording system clock. The clock update timing output circuit 23 outputs a clock frequency update timing signal 28 when the value of an address information 22 increase from its initial value exceeds a predefined value. The clock frequency setup information 27 and clock frequency update timing signal 28 enter a clock frequency setup circuit 29. When the clock frequency update timing signal 28 is entered, the clock frequency setup circuit 29 updates the setup for a clock generation circuit 30 in accordance with the current clock frequency setup information 27. The clock generation circuit 30 generates a clock having a frequency based on frequency divider setup information 35, which is given from the clock frequency setup circuit 29, and outputs the generated clock as a recording system clock 31.

The recording system clock 31 enters an encoding circuit 32 and a data recording circuit 33. Meanwhile, the information to be recorded into the optical disk 1 is entered from the external apparatus 13 to the interface circuit 10 through the use of the interface signal 12. The interface circuit 10 performs, for instance, a data buffering process with the buffer memory 11, which is connected to the interface circuit 10, and outputs recording information 18. The recording information 18 enters the recording system signal processing circuit 20. The recording information 18 is fed into the encoding circuit 32 within the recording system signal processing circuit 20. The encoding circuit 32 processes the recording information 18 in accordance with predetermined encoding rules to generate recording data 34. The recording data 34 enters the data recording circuit 33. The data recording circuit 33 generates a recording signal 19 by processing the recording data 34 for the purpose of exercising recording power control and recording strategy control, which are required for actual recording onto an optical disk.

The recording signal 19 enters a laser drive circuit (not shown) within the optical pickup 2. A laser (not shown) emits light with appropriate timing in accordance with the recording signal 19 to record information onto the optical disk 1. For information reproduction in an actual optical disk apparatus, various other circuits, including those for various servo systems, access system, error detection/correction system, and recording power/timing control system, also operate in coordination with each other. However, these circuits are not described herein because they do not directly relate to the present invention.

A process for CAV recording onto the optical disk will now be described. For CAV recording, the motor 15 needs to be rotated at a specified speed. In CAV recording, after recording on the disk, the recorded data linear density on the CD-R disk should be constant while the track scanning linear velocity varies with the radial position. Therefore, the amount of data recording per unit time, that is, the data recording rate, varies with the recording position radius during recording. To perform proper data recording, therefore, it is necessary to successively determine an appropriate data recording rate and adjust the actual data recording rate for it.

The present invention assumes that an appropriate data recording rate is calculated from address information to perform CAV recording. A method for deriving a data recording rate on the above assumption will now be described.

The actual data recording rate Rᵣ is required for data recording rate derivation. However, since the reference data recording rate Rₛ is constant, the intended purpose is practically achieved by determining the ratio between these two rates k (=Rᵣ/Rₛ).

For data recording rate calculation, the disk's reference linear velocity Vₛ is first determined. In other words, the wobble signal frequency f_{wo} is measured with a known disk radius r₀, and then the reference linear velocity is determined from the following two equations:

Vᵣ₀=2πr₀·N (Equation 8)

Vₛ=Vᵣ₀·(fₛ/f_{w0}) (Equation 9)

In the above equations, N is the disk rotation speed and f₅ is the reference wobble frequency.

As described earlier, the wobble signal is noisy during recording so that frequency measurements cannot easily be made. For determining the value Vₛ, however, the value f_{wo} may be measured during reproduction. It need not always be measured during recording. While reproduction is in progress, the wobble signal is not noisy so that frequency measurements can easily be made. Therefore, no significant Vₛ measurement problem arises. The value N is required for calculating the value Vₛ. However, the disk rotation speed N is self-evident as far as the spindle motor control system exercises proper control to maintain a constant rotation speed as described earlier. Thus, the value Vₛ can be determined as described above.

The actual Rᵣ value will now be determined. The process for determining the actual Rᵣ value is performed by the recording position detection circuit 24, which uses the address information 22 detected by the address information detection circuit 21 and the disk information 17. The result of this process is output as the data recording position information 25.

It is assumed that the radius r₂ is r₁+Δr for recording the position of the address T₂=T₁+ΔT at a known radius r₁ with reference to known address information T₁. In general, the T₁-to-T₂ distance L can be expressed as Vₛ·ΔT. The value Δr can be determined from Δr=F (r₁, L, Tₚ). Therefore, if the value Tₚ is known, the value r₂ can be determined (Tₚ=track pitch). Next, the value Vᵣ is obtained when the following equation is used:

Vᵣ=2·r₂·N (Equation 10)

As regards the address information T₁ for the initial radius r₁, the radius for the existence of specific address information (e.g., 0 minute, 0 second, 0 block) is defined by a standard or the like. It is therefore preferred that the radius be measured for use. As regards the measurement of the track pitch Tₚ, calculations may be performed from a measurement result that is obtained through the use of a movement distance detection encoder, which measures the distance traveled when the position is changed by a specified number of tracks. An alternative is to perform calculations from a track counting result, which indicates the number of tracks that are crossed when a stepping motor or the like is used to mechanically move the position over a specified distance.

As described above, the value Rᵣ at a specific position can be determined from address information. To calculate the value, it is necessary, as mentioned above, to measure the values necessary for calculations and perform condition setup and other processes to prepare for measurements. The present invention performs these processes with a microcomputer and software. These processes need not always be performed by software. If the value Rᵣ can be calculated, the processes may be performed by hardware.

Next, a process for acquiring the clock frequency setup information 27 with the clock frequency calculation circuit 26 in accordance with the value Rᵣ, which is obtained as the data recording position information 25, will be described. More specifically, this process is performed to calculate a target recording system clock frequency and then determine the recording system clock frequency setting to be actually employed. The target clock frequency is a theoretical value, which might represent a frequency that cannot be generated by the actually employed clock generation circuit. Even if the target clock frequency cannot be generated, no problem arises as far as the recording system clock frequency setting is within a permissible range of deviation from the target recording system clock frequency. A method for setting the recording system clock frequency will be described below.

First of all, the permissible level of frequency difference between the target recording system clock frequency and recording system clock frequency will be described. In general, when an optical disk is mounted in a recording apparatus, the virtual center of the optical disk does not perfectly align with that of a turntable. The virtual center of the optical disk slightly deviates from that of the turntable. This deviation is herein referred to as eccentricity. In a disk retention mechanism of a normal recording apparatus, an eccentricity of approximately 100×10⁻⁶ m readily occurs. If such an eccentricity exists, the distance between an optical spot and turntable virtual center varies in the form of a sine wave during a revolution. Therefore, the linear velocity varies in the same manner even if the spindle motor rotation speed is constant. As a result, the recording system clock frequency also varies sinusoidally in accordance with the degree of eccentricity during a revolution′. If, for instance, an eccentricity of +100×10⁻⁶ m exists at a radius of 30×10⁻³ m, the radius varies from 29.9×10⁻³ m to 30.1×10⁻³ m. Therefore, the resulting recording system clock frequency change is (±100×10⁻⁶ m/30×10⁻³ m)×100=±0.33%.

A spindle motor rotation speed change will now be described. As described earlier, CAV control is exercised so that the spindle motor rotates at a virtually fixed speed. However, when microscopically viewed, the spindle motor rotation speed varies. The reason for such a microscopic variation will now be described. A three-phase brushless motor is frequently employed as the spindle motor. As mentioned earlier, a hall element is used for magnetic pole detection. The hall element is required for each phase. Therefore, three hall elements are positioned in such a manner that the signals from the hall elements are 120 degrees out of phase with each other. The mounting positions of the hall elements are in mechanical error. Further, the three hall elements vary from each other in sensitivity. Furthermore, magnetized strength of the rotors made of a permanent magnet are varying. As a result, output signal of the hall elements have jitter. The jitter causes the rotation speed to vary during a single revolution. It is generally said that such rotation speed variation is approximately ±0.5%.

As is obvious from the foregoing description, the rotation speed variation is caused by the sum of eccentricity and motor-related factors. It should be assumed that the rotation speed variation is approximately 1%. This microscopic rotation speed variation cannot readily be suppressed by rotation speed control. It is estimated that the same degree of rotation speed variation occurs no matter whether CAV control or CLV control is exercised. In other words, although the above-mentioned degree of rotation speed variation occurs in a recording apparatus for conventional CLV recording, such rotation speed variation causes no practical problem.

In accordance with the above estimation, the present invention assumes that the maximum permissible level of frequency difference between the target recording system clock frequency and recording system clock frequency is ±1%. Preferably, the permissible level of frequency difference should be approximately ±0.3%, which is equivalent to variation caused by eccentricity. Since the recording system clock frequency is set so that its difference from the target recording system clock frequency does not exceed ±0.3%, the frequency resolution of the clock generation circuit should be ±0.3% or less.

The clock generation circuit 30 will now be described in detail. The clock generation circuit can be conventionally implemented by using a circuit known as a frequency synthesizer. FIG. 3 is a block diagram illustrating a frequency synthesizer that is used for the clock generation circuit 30. When a signal having a reference frequency of fₛ is entered, the frequency synthesizer outputs the following frequency f₀:

f₀=fₛ·(M/N)·(1/L) (Equation 11)

The value f₀ can be varied by changing internal frequency divider settings L, M, and N. The values L, M, and N are natural numbers.

The frequency synthesizer will now be described with reference to FIG. 3. The reference numeral 40 denotes a reference frequency signal source, which is a crystal oscillator, ceramic oscillator, or other stable signal source (oscillation element) having a frequency of fₛ. A reference frequency signal 46, which is output from the reference frequency signal source 40, is divided by a first frequency divider 41. The resulting signal is an N-divided signal 47. The reference numeral 44 denotes a VCO (voltage-controlled oscillator). A VCO control signal 50 is used to vary the frequency f_{vco} of a VCO output signal 51. The VCO output signal 51 is divided by a second frequency divider 45. The resulting signal is an M-divided signal 48.

The N-divided signal 47 and M-divided signal 48 enter a frequency/phase comparator circuit 42. The frequency/phase comparator circuit 42 outputs a error signal 49 in accordance with a frequency/phase difference between the two signals. The error signal 49 enters a low-pass filter 43. High-frequency components are then attenuated so that the VCO control signal 50 is obtained. The first frequency divider's frequency division ratio N can be set according to a first frequency divider setting 52. The second frequency divider's frequency division ratio M can be set according to a second frequency divider setting 53. The third frequency divider's frequency division ratio L can be set according to a third frequency divider setting 54. These frequency divider settings are generated from frequency divider setup information 35 by a frequency division value setup circuit 56.

The frequency synthesizer is a kind of feedback control system. The oscillation frequency f_{vco} of the VCO 44 is controlled so that fₛ/N=f_{vco}/M. Therefore, the frequency f_{vco} of the VCO output signal 51 is as follows:

f_{vco}=fₛ·(M/N) (Equation 12)

The recording system clock frequency f₀ is as follows:

f₀=f_{vco}·(1/L)=fₛ(M/N)·(1/L) (Equation 13)

Signals having various frequencies can be generated by setting frequency division ratios L, M, and N.

Consequently, the clock generation circuit frequency resolution of the frequency synthesizer can be set at ±0.3% or less most easily by setting at least either the value M or N to 300 or greater within the operating range and making a circuit design so as to obtain a desired recording system clock frequency resolution while ensuring that the recording system clock frequency change rate prevailing upon a setting change of 1 does not exceed 0.3%.

The process described above is performed. The clock frequency setup circuit 29 calculates the frequency divider setup information 35. In accordance with the frequency divider setup information 35, the clock generation circuit 30 determines the settings for the internal frequency dividers.

The present invention sets the recording system clock frequency by calculating the target recording system clock frequency in accordance with detected address information. Under normal conditions, address detection is performed at all times. When address detection is properly achieved, the recording system clock frequency can always be set. In this manner, the recording system clock frequency error can be minimized during recording. As described earlier, no practical problem arises as far as the clock frequency error is within the permissible range. In reality, however, correct address detection may not always be achieved during recording. In some cases, an incorrect address may be detected. Therefore, no advantage is provided even when the clock frequency update intervals are shortened in order to reduce the frequency error. It is important that the address information reliability be enhanced to correctly update the recording system clock frequency.

The process that the clock update timing output circuit 23 performs to output the clock frequency update timing information 28 will now be described. Whenever the address information to be updated or the address information subsequent to the address information to be updated is detected, the present invention updates the recording system clock frequency as appropriate for the detected address information.

The use of a CD-R will now be described as a concrete example. The CD-R address information is arranged in the minute, second, and block order. It is assumed herein that an update is performed when the “second” value exceeds either 0 or 30.

In the above case, an update is performed at 0 seconds and at 30 seconds as far as the address information is properly read. If the address information becomes unreadable after an update at 0 seconds and the next successfully read address information is at 40 seconds, the recording system clock frequency is updated using the address information at 40 seconds. In this instance, the next update is performed when the “second” value reverts to 0. In this manner, an update is usually performed at prescribed intervals so that an update can be performed at shortest intervals in the event of a reading failure. A simple alternative is to perform an update when an address change greater than predetermined is detected since the last clock frequency update. If, in this instance, the address information becomes unreadable after an update at 0 seconds and the next successfully read address information is at 40 seconds, the recording system clock frequency is updated in accordance with the address information prevailing at 40 seconds. In such an instance, the next update is performed 30 seconds later, that is, at 10 seconds.

When the clock frequency update timing information 28 is entered, the clock frequency setup circuit 29 updates the clock frequency setup information 27 to the latest clock frequency setup information. Therefore, while the clock frequency is updated with predefined timing, the encoding circuit 32 and data recording circuit 33 operate with reference to the recording system clock 31. As a result, information can be recorded onto the optical disk 1 at a predefined data recording rate that corresponds to the recording system clock frequency.

In the above case, it is assumed that the recording system clock is updated whenever the address advances for a period of 30 seconds. In such a case, the recording system clock change rate is approximately 0.9% in the innermost track and approximately 0.4% in the outermost track. It is therefore preferred that the frequency resolution of the actual recording system clock be ±0.4% or less as described above. A method for achieving such a resolution will be described below.

As an example, trial calculations will now be performed to determine a required setup for changing the value f₀ from 4.3218 MHz to 10.3723 MHz while L=1 and fₛ=33.8688 MHz. When (M,N)=(39,306), f₀=4.3166 MHz. When (M,N)=(39,305), f₀=4.3308 MHz. When (M,N)=(39,128), f₀=10.3194 MHz. When (M,N)=(39,127), f₀=10.4007 MHz. In this instance, the amount of frequency change between adjacent settings is 0.33% (±0.165%) when (M,N)=(39,306) to (39,305). It means that the target frequency resolution is achieved. However, when (M,N)=(39,128) to (39,127), the value N is small so that the amount of frequency change between adjacent settings is 0.79% (+0.395%). It means that the target frequency resolution is not achieved. To achieve a target frequency resolution of ±0.3% or less, it is necessary to set sufficiently great values for N and M. However, many limitations are imposed as mentioned earlier when frequency division ratios M and N are great.

Under these circumstances, the present invention dynamically changes either or both of the settings for the first frequency divider 41 and second frequency divider 45 in order to achieve a required frequency resolution without using a frequency divider having a great frequency division ratio.

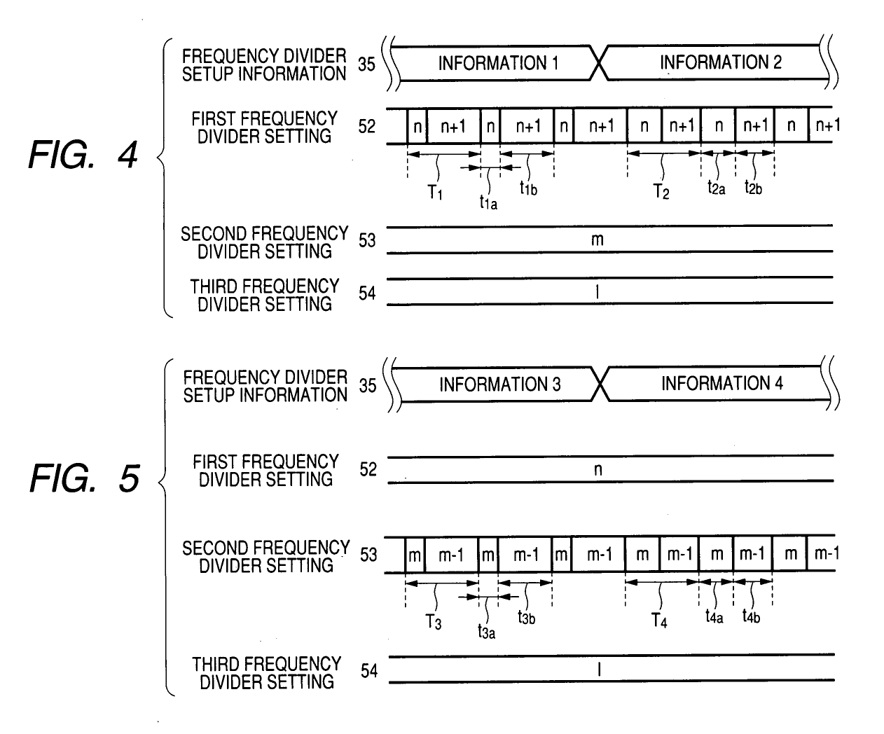

FIG. 4 is a timing diagram that shows how the frequency division value setup circuit 56 according to the present embodiment changes the frequency division setting 52 for the first frequency divider 41. The frequency division setting change will now be described with reference to the timing diagram. The frequency division value setup circuit 56 changes the first to third frequency divider settings 52, 53, 54 with predetermined timing in compliance with the entered frequency divider setup information 35.

If, for instance, the frequency divider setup information 35 is information 1, the information to be set for the first frequency divider is n and n+1 in accordance with the frequency divider setup information. The period for switching between n and n+1 is T₁. The length of time set up on n is t₁ₐ. The length of time set up on n+1 is t_{1b}. The second frequency divider setting 53 and third frequency divider setting 54 are fixed at m and 1, respectively. Under these conditions, control is exercised as shown in the diagram.

If, for′ instance, the frequency divider setup information 35 changes to information 2, the information to be set for the first frequency divider is n or n+1 in accordance with the frequency divider setup information. The period for switching between n and n+1 is T₂. The length of time set up on n is t₂ₐ. The length of time set up on n+1 is t_{2b}. The second frequency divider setting 53 and third frequency divider setting 54 are fixed at m and l, respectively. Under these conditions, control is exercised as shown in the diagram.

When the above control is exercised, the following equation is obtained:

α₁=t₁ₐ/(t₁ₐ+t_{1b})=t_{1a/}T₁ (Equation 14)

In general, when the expression indicated in Equation 15 is used, Equation 16 is obtained.

α=tₐ/(tₐ+t_{b})=tₐ/T (Equation 15)

f₀=fₛ·[m/{α·n+(1−α)(n+1)}]·(1/1) (Equation 16)

Therefore, when only the value α changes while the other settings remain unchanged as in the case of an information 1-to-information 2 change in the present embodiment, only the average value N (N=αn·(1−α)(n+1)) of the first frequency divider setting 52 changes. Since, in the present embodiment, the value N decreases with an increase in the value α, the value f₀ increases.

As described above, the value f₀ can be controlled by varying the value α. In this instance, the value that can be taken on by N is between n and n+1. The resolution of α is determined by the time settings for ta and tb. Therefore, it is possible to achieve an f₀ frequency resolution higher than those provided by conventional technologies by appropriately selecting a tₐ/t_{b} combination. If, for instance, a tₐ/t_{b} combination is prepared so as to ensure that α=0, 0.25, 0.5, 0.75, the f₀ output can be generated at a resolution that is obtained by dividing a frequency between the following two by four:

f₀₁fₛ·(m/n)·(1/1) (Equation 17)

f₀₂=fₛ·{m/(n+1)}·(1/1) (Equation 18)

FIG. 5 is a timing diagram that shows how the frequency division value setup circuit 56 according to the present embodiment changes the frequency division setting 53 for the second frequency divider 42. The frequency division setting change will now be described with reference to the timing diagram. The frequency division value setup circuit 56 changes the first to third frequency divider settings 52, 53, 54 with predetermined timing in compliance with the entered frequency divider setup information 35. If, for instance, the frequency divider setup information 35 is information 3, the information to be set for the second frequency divider is m or m−1 in accordance with the frequency divider setup information. The period for switching between m and m−1 is T₃. The length of time set up on m′ is t₃ₐ. The length of time set up on m−1 is t_{3b}. The first frequency divider setting 52 and third frequency divider setting 54 are fixed at n and 1, respectively. Under these conditions, control is exercised as shown in the diagram.

If, for instance, the frequency divider setup information 35 changes to information 4, the information to be set for the first frequency divider is m or m−1 in accordance with the frequency divider setup information. The period for switching between m and m−1 is T₄. The length of time set up on m is t₄ₐ. The length of time set up on m−1 is t_{4b}. The first frequency divider setting 52 and third frequency divider setting 54 are fixed at n and l, respectively. Under these conditions, control is exercised as shown in the diagram.

When the above control is exercised, the following equation is obtained:

β₃=t₃ₐ/(t₃ₐ+t_{3b})=t₃ₐ/T₃ (Equation 19)

In general, when the expression indicated in Equation 20 is used, Equation 21 is obtained.

β=tₐ/(tₐ+t_{b})=tₐ/T (Equation 20)

f₀=fₛ·[{β·m+(1−β)(m−1)}/n]·(1/1) (Equation 21)

Therefore, when only the value β changes while the other settings remain unchanged as in the case of an information 3-to-information 4 change in the present embodiment, only the average value M (M=β+(1−β)(m−1)) of the second frequency divider setting 53 changes. Since, in the present embodiment, the value M increases with an increase in the value β, the value f₀ increases.

As described above, the value f₀ can be controlled by varying the value β. In this instance, the value that can be taken on by M is between m and m−1. The resolution of β is determined by the time settings for tₐ and t_{b}. Therefore, it is possible to achieve an f₀ frequency resolution higher than those provided by conventional technologies by appropriately selecting a tₐ/t_{b} combination. If, for instance, a tₐ/t_{b} combination is prepared so as to ensure that β=0, 0.1, 0.2, . . . , 0.7, 0.8, 0.9, the f₀ output can be generated at a resolution that is obtained by dividing a frequency between the following two by ten:

f₀₃=fₛ·(m/n)·(1/1) (Equation 22)

f₀₄=fₛ·{(m−1)/n}·(1/1) (Equation 23)

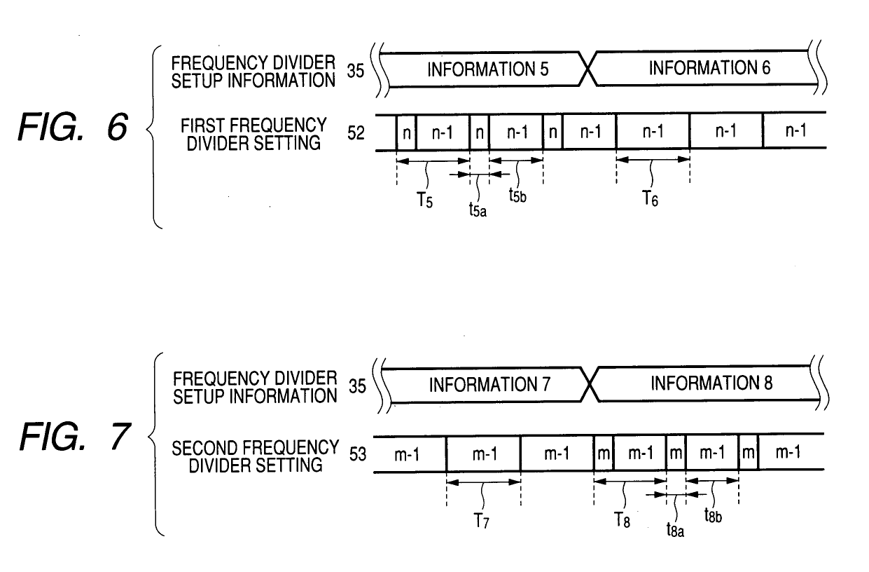

FIG. 6 is a timing diagram that shows how the frequency division value setup circuit 56 according to the present embodiment changes the frequency division setting 52 for the first frequency divider 41. This timing diagram relates to an example shown in FIG. 4 but indicates a special case. The frequency division setting change will now be described with reference to the timing diagram.

If the frequency divider setup information 35 is information 5, the information to be set for the first frequency divider is n or n−1 in accordance with the frequency divider setup information. The period for switching between n and n−1 is T₅. The length of time set up on n is t₅ₐ. The length of time set up on n−1 is t_{5b}. The second frequency divider setting 53 and third frequency divider setting 54 are fixed at m and l, respectively. Under these conditions, control is exercised as shown in the diagram.

If the frequency divider setup information 35 changes to information 6, the information to be set for the first frequency divider is n−1 only. No value other than n−1 is to be selected by switching. The second frequency divider setting 53 and third frequency divider setting 54 are fixed at m and l, respectively. Under these conditions, control is exercised as shown in the diagram. If it is assumed that T₆=t_{6b} and that t₆ₐ=0, the situation is essentially the same as indicated in FIG. 4.

FIG. 7 is a timing diagram that shows how the frequency division value setup circuit 56 according to the present embodiment changes the frequency division setting 53 for the second frequency divider 42. This timing diagram relates to an example shown in FIG. 5 but indicates a special case. The frequency division setting change will now be described with reference to the timing diagram.

If the frequency divider setup information 35 is information 7, the information to be set for the first frequency divider is m−1 only in accordance with the frequency divider setup information. No value other than m−1 is to be selected by switching. The second frequency divider setting 53 and third frequency divider setting 54 are fixed at m and 1, respectively. Under these conditions, control is exercised as shown in the diagram.

If the frequency divider setup information 35 changes to information 8, the information to be set for the first frequency divider is m or m−1 in accordance with the frequency divider setup information. The period for switching between m and m−1 is T₈. The length of time set up on m is t₈ₐ. The length of time set up on m−1 is t_{8b}. The first frequency divider setting 52 and third frequency divider setting 54 are fixed at n and l, respectively. Under these conditions, control is exercised as shown in the diagram. If it is assumed that T₇=t_{7b} and that t₇ₐ=0, the situation is essentially the same as indicated in FIG. 5.

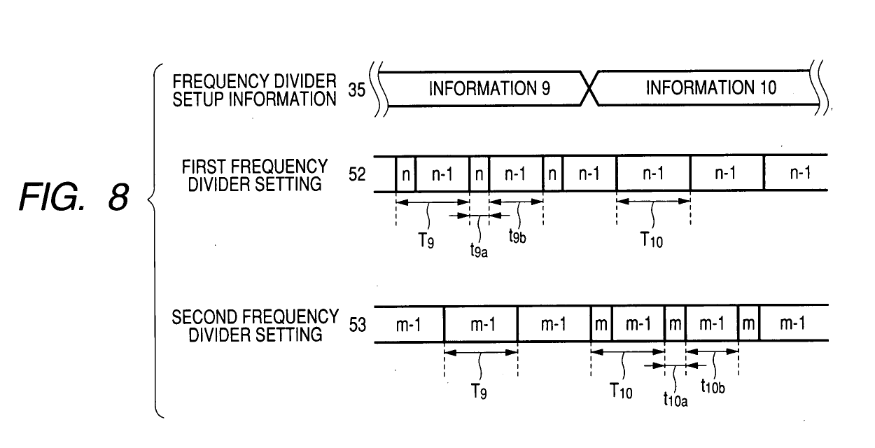

If the cases shown in FIG. 4 and FIG. 5 are extended, it is readily conceivable as indicated in FIG. 8 that the combinations of the first frequency divider setting 52 and second frequency divider setting 53 may be simultaneously changed in accordance with the frequency divider setup information 35.

The present embodiment described with reference to FIGS. 4 through 7 will now be described in more general terms. The clock generation means for generating the recording system clock is configured so that a clock signal having a frequency f₀ of fₛ·(M/N) (M and N are natural numbers) can be generated with the frequency synthesizer circuit on the basis of a reference frequency signal source having a frequency of fₛ and in accordance with the clock frequency setup information. The value M and its adjacent value M′ are alternately selected. Further, M and M′ changeover timing is controlled to vary the ratio of time α during which the value M is taken on. Meanwhile, the value N and its adjacent value N′ are alternately selected. Further, N and N′ changeover timing is controlled to vary the ratio of time β during which the value N is taken on. Control is exercised so that the frequency of the clock signal generated by the frequency synthesize is as follows:

f₀=fₛ·{M·α+M′·(1−α)}/{N·β+N′·(1−β)} (Equation 24)

As mentioned above, the values M′ and N′ are the adjacent values of the values M and N, respectively. In more general terms, however, the values M′ and N′ need not be the adjacent values of the values M and N. Therefore, the clock generation means for generating the recording system clock is configured so that a clock signal having a frequency f₀ of fₛ·(M/N) (M and N are natural numbers) can be generated with the frequency synthesizer circuit on the basis of a reference frequency signal source having a frequency of fₛ and in accordance with the clock frequency setup information. The value M alternates between p and q. Further, p and q changeover timing is controlled to vary the value α. Meanwhile, the value N alternates between r and s. Further, r and s changeover timing is controlled to vary the value β. Control is exercised so that the frequency of the clock signal generated by the frequency synthesize is as follows:

f₀=fₛ·{p·α+q·(1−α)}/{r·β+s·(1−β)} (Equation 25)

In the above description, the frequency division value setup circuit 56 changes the first to third frequency divider settings 52, 53, 54 as needed with predetermined timing in accordance with the entered frequency divider setup information 35. However, when the recording system clock frequency is raised while the recording position shifts from the innermost track to the outermost track during CAV recording, the process is performed to achieve the specified frequency resolution by changing the frequency divider settings with time. Therefore, a relatively high degree of arithmetic processing needs to be performed. Under these circumstances, arithmetic units such as a microcomputer and digital signal processor may be used in conjunction with the above arithmetic processing program and hardware logic circuit.

The relationship among the intervals T for frequency division setting changeover, the times tₐ, t_{b} during which the settings persist, and the cut-off frequency fLPF of the low-pass filter 43 will now be described. The low-pass filter 43 improves the frequency spectrum purity of the frequency synthesizer output signal by attenuating the high-frequency components of a error signal output from the frequency/phase comparator circuit 42 and by reducing the high-frequency components of a control signal of the VCO 44, which turn out to be out-of-band noise. When a common frequency synthesizer is used, the frequency divider setting will not frequently be changed once it is entered. Therefore, the low-pass filter cut-off frequency is determined while considering, for example, the frequency settling time required upon a setting change and the phase noise contained in the VCO output signal. However, when the frequency synthesizer according to the present invention is used, the frequency divider setting changes at intervals T, and setting changes cause a frequency/phase error of the frequency division signal, thereby incurring noise of the VCO control signal 50. To suppress noise of the VCO control signal 50 and improve the frequency spectrum purity of the frequency synthesizer output signal, therefore, it is necessary to reduce the noise that is generated upon above-mentioned setting changes. To lessen the influence of noise generated upon setting changes, the present invention defines the relationship between the frequency division setting change intervals T and cut-off frequency f_{LPF} of the low-pass filter 43 as indicated in the example below:

1/T>f_{LPF} (Equation 26)

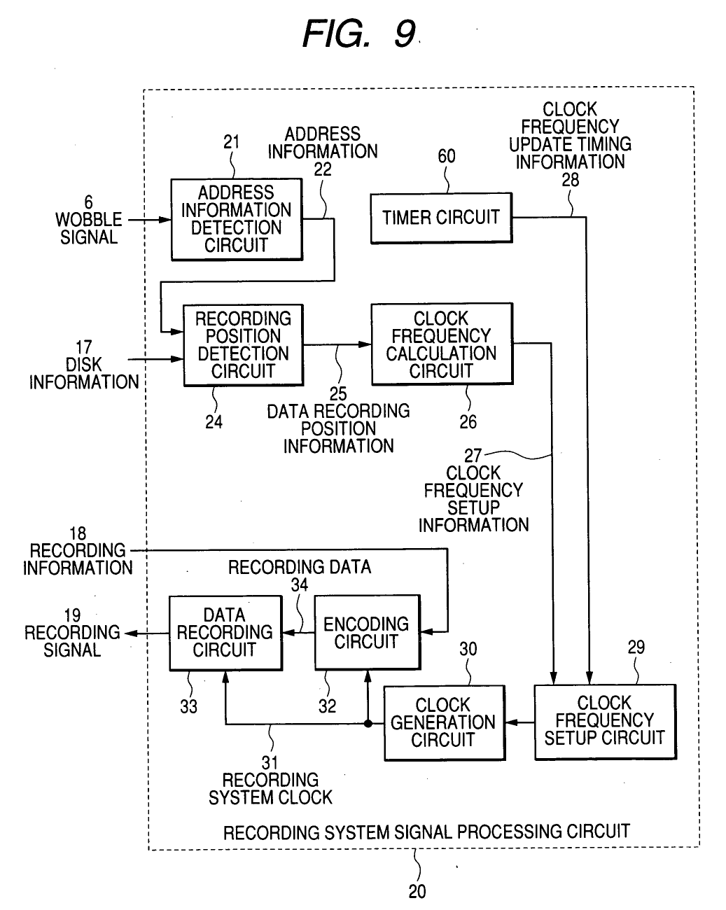

A second embodiment of the present invention will now be described. FIG. 9 is a block diagram illustrating the recording system signal processing circuit 20 according to the second embodiment of the present invention. The difference between the second embodiment and first embodiment will now be summarized. In the first embodiment, the clock frequency update timing signal 28 is created by the clock update timing output circuit 23 in accordance with the address information 22. In the second embodiment, however, the clock frequency update timing signal 28 is created by a timer circuit 60. More specifically, the timer circuit 60 starts running the moment a recording operation starts. Subsequently, the clock frequency update timing signal 28 is output each time the time set for the timer circuit 60 elapses.

In the second embodiment, the recording system clock frequency update does not depend on the detection of the address information 22. Therefore, the employed circuitry is rendered simple. Even if an address is not easily read, an update can be performed apparently at predetermined time intervals. In the other respects, the second embodiment is the same as the first embodiment. Therefore, all the details of the second embodiment are not described herein.

As is the case with the first embodiment, the second embodiment makes it possible to perform software-based processing with a microcomputer or the like.

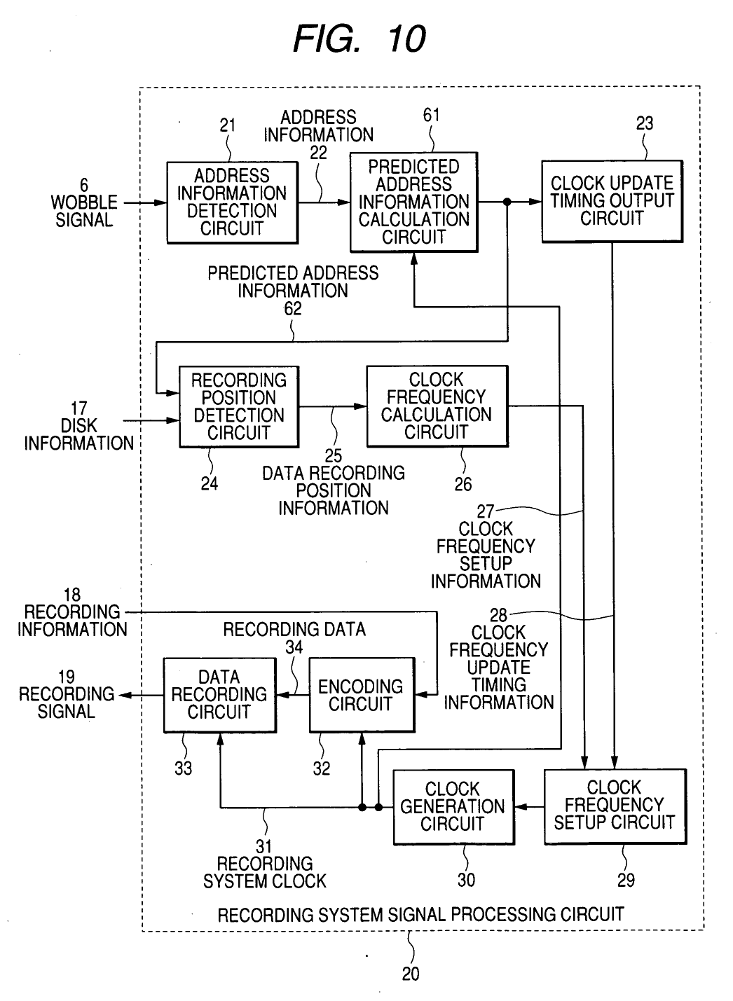

A third embodiment of the present invention will now be described. FIG. 10 is a block diagram illustrating the recording system signal processing circuit 20 according to the third embodiment of the present invention. The difference between the third embodiment and first embodiment will now be summarized. In the first embodiment, the clock frequency update timing signal 28 and data recording position information 25 are created in accordance with the address information 22. In the third embodiment, however, the clock frequency update timing signal 28 and data recording position information 25 are created in accordance with predicted address information 62. A predicted address information calculation circuit 61 is provided to predict current address information in accordance with the address information 22 and recording system clock 31 prevailing at a certain time in the past. In principle, the amount of data can be determined when the number of recording system clocks 31 is counted, and the amount of data recorded between addresses remains unchanged. Address prediction is based on such a principle. More specifically, when the value obtained by counting the number of recording system clocks 31 beginning with an arbitrary address A₀, which is encountered after the start of recording, is N_{c}, the number of data contained in between neighboring addresses is Nₐ, and N_{c}/Nₐ=Δp, the address A₁ prevailing when the value Δp is an integer is A0+Δp. Therefore, when the address A₀ detected while the address information is highly reliable and the subsequent recording system clock count are known, the subsequent address start position and its value can be determined. Theoretically speaking, once a correct address is obtained, the present embodiment can predict address information even if no subsequent address information is acquired at all. Therefore, even when a correct address is not readily obtained due to low address information reliability, the intended purpose can be achieved with a predicted address. In the other respects, the third embodiment is the same as the first embodiment. Therefore, all the details of the third embodiment are not described herein.

As is the case with the first embodiment, the third embodiment makes it possible to perform software-based processing with a microcomputer or the like.

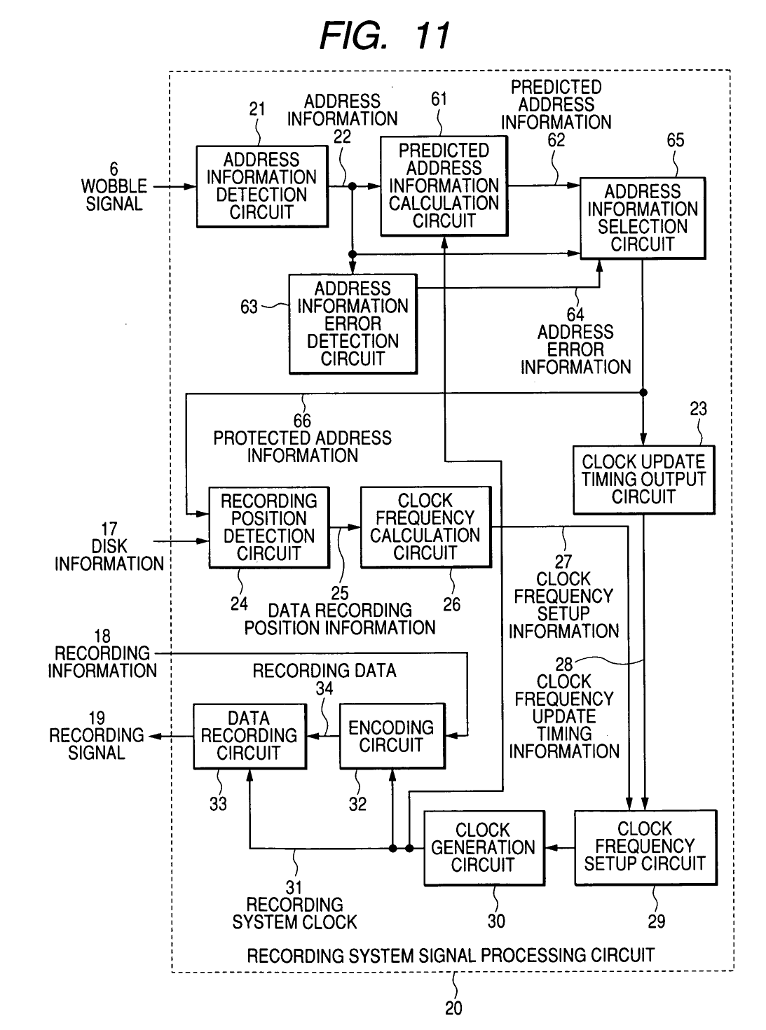

A fourth embodiment of the present invention will now be described. FIG. 11 is a block diagram illustrating the recording system signal processing circuit 20 according to the fourth embodiment of the present invention. The difference between the fourth embodiment and third embodiment will now be summarized. In the third embodiment, the predicted address information 62 is used for the recording position detection circuit 24 and clock update timing output circuit 23. In the fourth embodiment, however, either the predicted address information 62 or the address information 22 is used for the recording position detection circuit 24 and clock update timing output circuit 23. An address information selection circuit 65 selects either the predicted address information 62 or the address information 22 by using address error information 64, which is output from an address information error detection circuit 63. More specifically, if the address error information 64 indicates that no address error is encountered, the address information selection circuit 65 selects the address information 22. If, on the other hand, the address error information 64 indicates that an address error is encountered, the address information selection circuit 65 uses the predicted address information 62. The address information selection circuit 65 then outputs the signal for the selected information as protected address information 66. The protected address information 66 is highly reliable at all times because either correct address information 22 or predicted address information 62 is automatically selected in accordance with the address error information 64. The fourth embodiment automatically acquires highly reliable address information. In the other respects, the fourth embodiment is the same as the first embodiment. Therefore, all the details of the fourth embodiment are not described herein.

As is the case with the first embodiment, the fourth embodiment makes it possible to perform software-based processing with a microcomputer or the like.

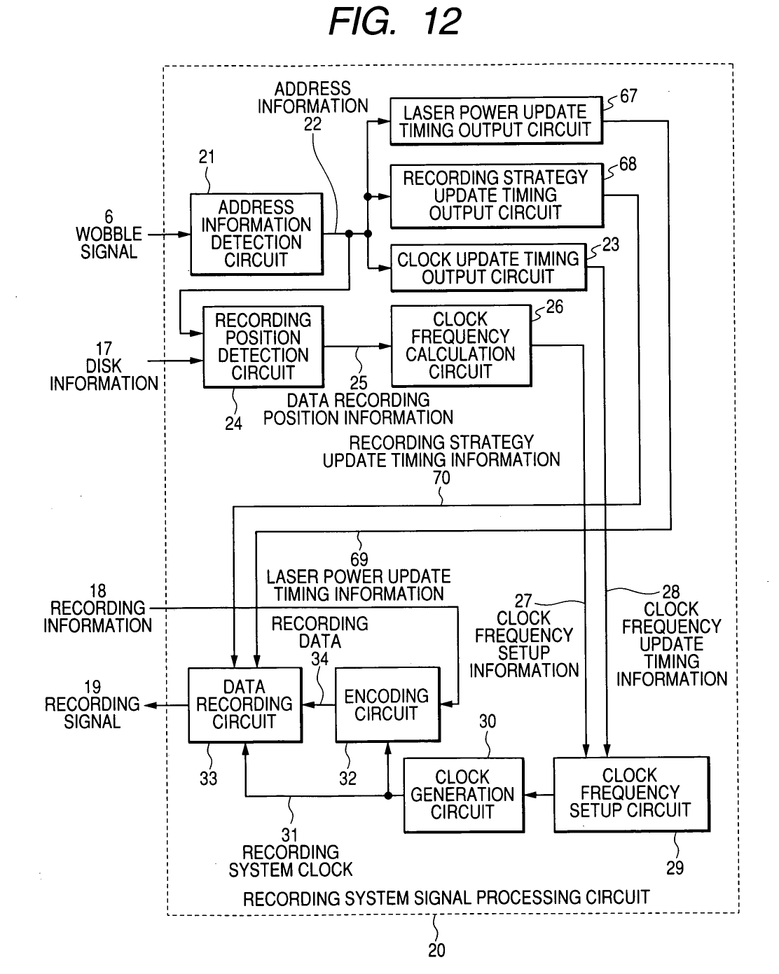

A fifth embodiment of the present invention will now be described. FIG. 12 is a block diagram illustrating the recording system signal processing circuit 20 according to the fifth embodiment of the present invention. The difference between the fifth embodiment and first embodiment will now be summarized. In the fifth embodiment, a laser power update timing output circuit 67 and a recording strategy update timing output circuit 68 are provided to output a laser power update timing signal 69 and a recording strategy update timing signal 70, respectively.

In CAV recording, the recording rate and linear velocity increase with an increase in the recording position radius. It is therefore necessary to increase the amount of light emission from the laser, which is required for recording or erasure. When the recording rate varies, the recording strategy generally needs to be varied. Under these circumstances, the present invention minutely controls the data recording conditions for CAV recording by adjusting the amount of light emission, recording strategy, and other data recording conditions for the recording position in accordance with the address information 22. The laser power update timing output circuit 67 and recording strategy update timing output circuit 68 have functions similar to those of the clock update timing output circuit 23. When specified address information 22 is detected, the laser power update timing output circuit 67 and recording strategy update timing output circuit 68 respectively output the laser power update timing signal 69 and recording strategy update timing signal 70 for the purpose of updating the laser power, recording strategy, and other recording conditions to be controlled. The laser power update timing signal 69, recording strategy update timing signal 70, and clock frequency update timing signal 28 are generally independent of each other and output at different times. However, they may be synchronously output at the same time. In such an instance, the signals to be output at the same time share a timing output circuit. In the fifth embodiment, the recording condition control system, which is essential to CAV recording, may double as a frequency control system for the recording system clock 31. Therefore the scale of employed circuitry can be reduced. Further, increased ease of control is provided because the same control method is used. The laser power update timing output circuit 67, recording strategy update timing output circuit 68, and clock update timing output circuit 23 are all incorporated in the present embodiment. However, the present invention may employ an alternative configuration in which either the laser power update timing output circuit 67 or the recording strategy update timing output circuit 68 is included. In the other respects, the fifth embodiment is the same as the first embodiment. Therefore, all the details of the fifth embodiment are not described herein.

As is the case with the first embodiment, the fifth embodiment makes it possible to perform software-based processing with a microcomputer or the like.

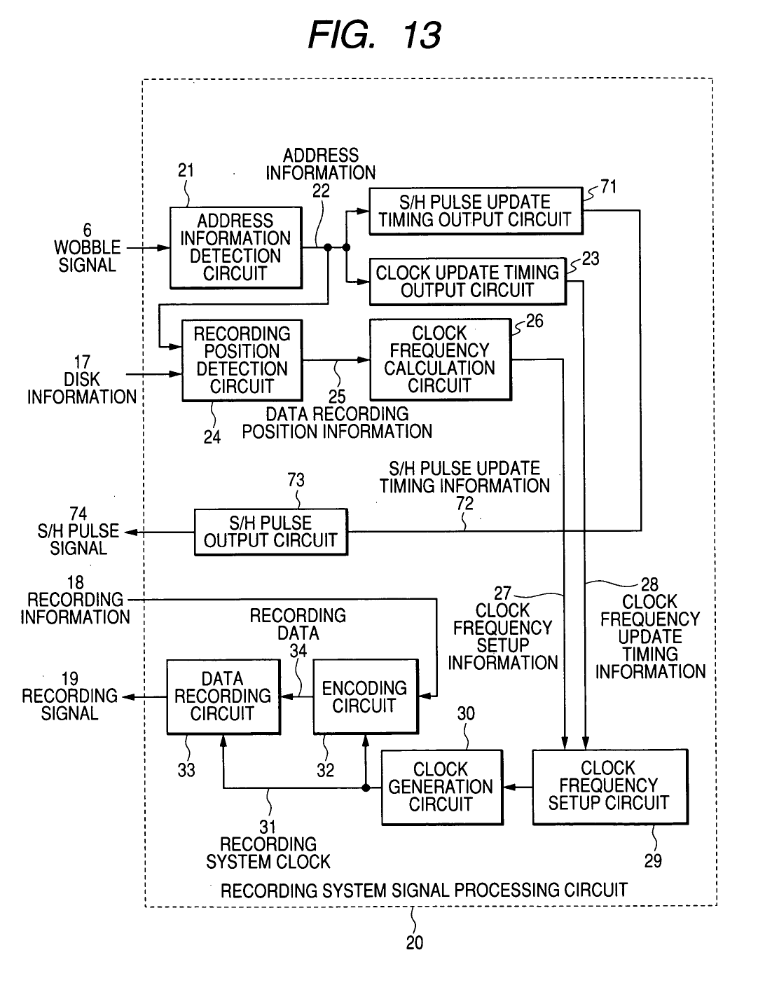

A sixth embodiment of the present invention will now be described. FIG. 13 is a block diagram illustrating the recording system signal processing circuit 20 according to the sixth embodiment of the present invention. The difference between the sixth embodiment and first embodiment will now be summarized. In the sixth embodiment, an S/H (sample-and-hold) pulse update timing output circuit 71, S/H pulse update timing information 72, and an S/H pulse output circuit 73 are additionally used to output an S/H pulse signal 74. The S/H pulse signal 74 (not shown) is connected to the front-end circuit 3, which is shown in FIG. 2.

As mentioned in conjunction with the fifth embodiment, when CAV recording is performed, the recording rate and linear velocity increase with an increase in the recording position radius. It is therefore necessary to vary the S/H pulse timing for sampling-and-holding the servo signal 5 and wobble signal 6. The reason is that recording-level laser power is output for a recording portion while reproduction-level laser power is output for a nonrecording portion. Therefore, when the optical pickup 2 achieves signal detection, the recording power radiation component and reproduction power radiation component are alternately detected. In this instance, the detection signal related to reproduction power needs to be subjected to sampling and holding. However, the optical pickup's detection signal change overshoots when a switch is made from recording power to reproduction power. As a result, a certain length of time (hereinafter referred to as the delay time) is required for signal stabilization. If the delay time remains unchanged during CAV recording, the S/H pulse timing need not be varied. In reality, however, it is necessary to increase the recording power in accordance with an increase in the recording rate. When the recording power increases, the level difference between the recording power and reproduction power enlarges, thereby increasing the length of delay time for a switch from the recording power to reproduction power. To constantly sample and hold the reproduction power radiation component, therefore, it is necessary to vary the S/H pulse timing in accordance with an increase in the recording power. Thus, the present invention controls the servo signal/wobble signal reproduction conditions for CAV recording by regulating the S/H pulse timing for the recording position in accordance with the address information 22. The S/H pulse update timing output circuit 71 has functions similar to those of the clock update timing output circuit 23. When specified address information 22 is detected, the S/H pulse update timing output circuit 71 outputs S/H pulse update timing information 72 for an S/H pulse timing update, and the S/H pulse output circuit 73 outputs an S/H pulse signal 74. The sixth embodiment provides stable reproduction of the servo signal and wobble signal during CAV recording, thereby stabilizing the servo system and the address information detection from the wobble signal. As a result, the recording quality improves. In the other respects, the sixth embodiment is the same as the first embodiment. Therefore, all the details of the sixth embodiment are not described herein.

As is the case with the first embodiment, the sixth embodiment makes it possible to perform software-based processing with a microcomputer or the like.

A seventh embodiment of the present invention will now be described. The difference between the seventh embodiment and first embodiment will now be summarized. In the seventh embodiment, a recording stop is detected from recording stop information. If it is concluded that a recording operation is stopped, the seventh embodiment does not check the address information for clock frequency update timing.

Occasionally, it is necessary to stop an ongoing recording operation no matter whether a CAV or other recording operation is performed. In a typical example, the external apparatus 13 initiates a process irrelevant to recording data output to the interface circuit 10 so that the recording information 18 cannot be continuously output. Thus, the buffer memory 11 does not buffer recording data and eventually becomes empty. This phenomenon is generally referred to as a buffer underrun. In the event of a buffer underrun, the recording operation cannot be continued because the recording data necessary for recording is not available. It is therefore necessary to stop the recording operation. When the recording operation is stopped, the recording system clock frequency update, which is performed during the recording operation, becomes meaningless. It is therefore preferred that the clock update be stopped. If the buffer memory 11 buffers recording data again to permit recording, and the recording operation resumes from a position at which the recording operation was stopped, the clock frequency calculation or other process need not be performed at the time of recording operation resumption as far as the clock update was stopped while the recording operation was halted, and the resumption of the clock update will suffice.

For the reason described above, if an ongoing recording operation needs to be stopped, the seventh embodiment halts the recording system clock update while the recording operation is stopped, and resumes the recording system clock update when the recording operation restarts. In CLV recording, the recording system clock frequency is constant, and it is needless to say that no clock frequency update is required. In CAV recording, which is performed by the present invention, however, the recording system clock is updated in accordance with the address information 22. Therefore, if an ongoing recording operation needs to be stopped, the recording stop information is used to judge whether or not to stop the recording operation. If the recording operation is to be stopped, the clock update timing check is not performed. Further, if the recording stop information is invalidated, the recording operation restarts. Therefore, the recording system clock update resumes in synchronism with the restart of the recording operation.

Even when a CAV recording operation is to be stopped, the seventh embodiment stops the recording system clock update. It is therefore easy to exercise recording system clock control when resuming the recording operation from a recording stop position. In the other respects, the seventh embodiment is the same as the first embodiment. Therefore, all the details of the seventh embodiment are not described herein.

The foregoing description of the embodiments according to the present invention has dealt with CAV recording onto a CD-R. However, the present invention is not limited to CAV recording. Even when the recording system clock according to the present invention is applied to Zone-CAV recoding or Zone-CLV recording, the recording accuracy can be rendered higher than in a case where the recording system clock resulting from wobble meandering is used. Further, the address information in the foregoing embodiments corresponds to ATIP because the description has dealt with the use of a CD-R. However, the same advantages are also provided when LPP (Land Pre-Pit) or ADIP (ADdress In Pre-groove) is used for recording onto a recordable DVD.

The present invention provides a higher degree of stability than in a case where a recording system clock is generated with a wobble signal, and performs data recording through the use of a recording system clock signal with a minimum of jitter. Therefore, the present invention reduces the error rate prevailing when a recorded signal is reproduced, and improves both data recording reliability and overall reproduction system reliability.

What is claimed is:

1. An optical disk apparatus that is capable of optically recording information onto a recordable optical disk having recording tracks in which address information is formed, the optical disk apparatus comprising:
drive means for rotating said recordable optical disk;
detection means for detecting address information that is recorded in said recording tracks;
an oscillation element for generating a signal having a specific frequency;
recording system clock generation means for generating a recording system clock having one of a plurality of selectable frequencies for recording onto said recordable optical disk with reference to a signal from said oscillation element;
clock update timing output means for outputting a clock update timing output signal for changing said recording system clock in accordance with said address information;
an encoder for generating the recording information to be recorded onto a recordable optical disk by using a clock that is output from said recording system clock generation means;
address difference detection means for detecting the difference between first address information, which is output from said detection means, and second address information, which is contained in the recording information output from said encoder; and
drive control means for controlling said drive means in accordance with an address difference that is output from said address difference detection means.

2. An optical disk apparatus that is capable of optically recording information onto a recordable optical disk having recording tracks in which address information is formed, the optical disk apparatus comprising:
drive means for rotating said recordable optical disk;
detection means for detecting address information that is recorded in said recording tracks;
an oscillation element for generating a signal having a specific frequency;
recording system clock generation means for generating a recording system clock having a plurality of time-division multiplexed frequencies for recording onto said recordable optical disk with reference to a signal from said oscillation element; and
clock update timing output means for outputting a clock update timing output signal for changing said recording system clock in accordance with said address information.

3. An optical disk apparatus that is capable of optically recording information onto a recordable optical disk having recording tracks in which address information is formed, the optical disk apparatus comprising:
drive means for rotating said recordable optical disk;
detection means for detecting address information that is recorded in said recording tracks;
an oscillation element for generating a signal having a specific frequency;
recording system clock generation means for generating a recording system clock having a plurality of selectable frequencies with time-division multiplexed settings for recording onto said recordable optical disk with reference to a signal from said oscillation element;
clock update timing output means for outputting a clock update timing output signal for changing said recording system clock in accordance with said address information;
address difference detection means for detecting the difference between first address information, which is formed in said recording tracks, and second address information, which is contained in the recording information to be recorded onto said recordable optical disk; and
drive control means for controlling said drive means in accordance with the result of detection of said address difference.

4. The optical disk apparatus according to claim 1, 2, or 3, wherein, when information is to be recorded onto said recordable optical disk, said recording system clock generation means generates a recording system clock having one of a plurality of selectable frequencies in such a manner that said optical disk substantially rotates at a CAV speed.

5. The optical disk apparatus according to claim 1, 2, or 3, wherein, when information is to be recorded onto said recordable optical disk, said recording system clock generation means generates a recording system clock having one of a plurality of selectable frequencies in such a manner that said optical disk substantially rotates at a CLV speed.

6. The optical disk apparatus according to claim 1, 2, or 3, wherein said recordable optical disk is an optical disk conforming to a recordable CD standard, an optical disk conforming to a recordable DVD standard, or an optical disk conforming to a recordable blue-violet laser optical disk standard.

7. The optical disk apparatus according to claim 1, 2, or 3, wherein said address information contains minute/second/block-related information or logical block-related information, and wherein encoding clock frequency control is exercised in accordance with the address information.

8. An information recording apparatus that is capable of recording information onto an information recording medium, the information recording apparatus comprising:
reproduction address information detection means for reproducing/demodulating address information that is prerecorded on an information recording medium;
encoding means for generating the recording data to be recorded onto said information recording medium;
data recording means for recording said recording data onto said information recording medium;
clock generation means for generating a recording system clock that serves as the reference for the operations of said encoding means and said data recording means;
clock frequency setup means for setting the frequency of said recording system clock frequency that is to be output from said clock generation means;
recording position detection means for detecting a data recording position on said information recording medium;
clock frequency calculation means for calculating a target recording system clock frequency in accordance with said address information and the information about said data recording position, and outputting clock frequency setup information to said clock frequency setup means;
recording address detection means for detecting recording address information that is contained in the recording data output from said encoding means;
address difference detection means for detecting the difference between reproduction address information detected by said address information detection means and recording address information detected by said recording address detection means; and
drive control means for controlling said drive means in accordance with the result of said address difference detection so that the address difference is smaller than predetermined;
wherein, when information is to be recorded onto an information recording medium, said encoding means and said data recording means records information onto the information recording medium in accordance with said recording system clock that is output from said clock generation means.

9. The information recording apparatus according to claim 8, wherein, when information is to be recorded onto an information recording medium, said address difference detection means detects an address difference between first address information, which is formed in a recording track at a recording position, and second address information, which is contained in the recording information to be recorded at said recording position of said recordable optical disk; and wherein said drive control means controls said drive means so as to render said detected address difference smaller than predetermined by increasing the rotation speed of said drive means when said first address information is ahead of said second address information by a value greater than predetermined or by decreasing the rotation speed of said drive means when said first address information is behind said second address information by a value greater than predetermined.

10. The information recording apparatus according to claim 8 or 9, wherein, when information is to be recorded onto an information recording medium, said clock frequency calculation means outputs said clock frequency setup information at predetermined time intervals and in accordance with said data recording position information and said address information.

11. The information recording apparatus according to claim 8 or 9, further comprising predicted address information calculation means for calculating predicted address information at a recording position from said reproduction address information and said recording system clock prevailing after the start of recording, wherein, when information is to be recorded onto an information recording medium, said clock frequency calculation means outputs said clock frequency setup information in accordance with said data recording position information and said predicted address information each time said predicted address information changes by a predetermined value.

12. The information recording apparatus according to claim 8 or 9, further comprising address information error detection means for detecting an error in said reproduction address information, which is detected by said reproduction address information detection means, and outputting address error information, wherein, when information is to be recorded onto an information recording medium, said clock frequency calculation means outputs said clock frequency setup information each time a predetermined value change occurs in verified address information containing no address error, which is verified according to said data recording position information and said address information.

13. The information recording apparatus according to claim 8 or 9, further comprising:
predicted address information calculation means for calculating predicted address information at a recording position from said reproduction address information and said recording system clock prevailing after the start of recording;
address information error detection means for detecting an error in said reproduction address information, which is detected by said reproduction address information detection means, and outputting address error information; and
address information selection means for selecting said reproduction address information from said reproduction address information and said predicted address information by said address error information when said address error information is correct, and selecting said predicted address information from said reproduction address information and said predicted address information by said address error information when said address error information is incorrect, and outputting the selected address information as a protected address information to the output;
wherein, when information is to be recorded onto an information recording medium, said clock frequency calculation means outputs said clock frequency setup information each time a predetermined value change occurs in said protected address information in accordance with said data recording position information and said protected address information.

14. The information recording apparatus according to claim 8, wherein, when information is to be recorded onto an information recording medium, the amount of optical energy incident on the information recording medium varies in synchronism with a setting update of said recording system clock frequency.

15. The information recording apparatus according to claim 8, wherein, when information is to be recorded onto an information recording medium, the change timing setting for an optical energy pulse application to the information recording medium varies in synchronism with a setting update of said recording system clock frequency.

16. The information recording apparatus according to claim 8, wherein said clock generation means uses a frequency synthesizer circuit, generates a clock signal having a predefined frequency that is selected from frequencies that the frequency synthesizer can output, and handles the generated clock signal as said recording system clock.

17. The information recording apparatus according to claim 8, wherein said clock generation means is capable of generating a clock signal having a frequency f₀ of fₛ (M/N) (M and N are natural numbers) with a frequency synthesizer circuit on the basis of a reference frequency signal source having a frequency of fₛ, and changing the setting of at least either said M or said N to a different value.

18. The information recording apparatus according to claim 8, wherein said clock generation means generates a clock signal having a frequency f₀ of fₛ·(M/N) (M and N are natural numbers) with a frequency synthesizer circuit on the basis of a reference frequency signal source having a frequency of fₛ, and changes the setting of at least either said M or said N to a value adjacent to the initial value with predefined timing.

19. The information recording apparatus according to claim 8, wherein said clock generation means is configured to generate a clock signal having a frequency f₀ of fₛ·(M/N) (M and N are natural numbers) with a frequency synthesizer circuit in accordance with said clock frequency setup information and on the basis of a reference frequency signal source having a frequency of fₛ, alternate between said M and adjacent value M′, control M and M′ changeover timing to determine the time ratio α for selecting the value M, and set the frequency of the clock signal to be generated by said frequency synthesizer circuit to f₀=fₛ·{M·α+M′·(1−α)}/N.

20. The information recording apparatus according to claim 8, wherein said clock generation means is configured to generate a clock signal having a frequency f₀ of fₛ·(M/N) (M and N are natural numbers) with a frequency synthesizer circuit in accordance with said clock frequency setup information and on the basis of a reference frequency signal source having a frequency of fₛ, alternate between said N and adjacent value N′, control N and N′ changeover timing to determine the time ratio β for selecting the value N, and set the frequency of the clock signal to be generated by said frequency synthesizer circuit to f₀=fₛ·M/{N/β+N′/(1−α)}.

21. The information recording apparatus according to claim 8, wherein said clock generation means is configured to generate a clock signal having a frequency f₀ of fₛ·(M/N) (M and N are natural numbers) with a frequency synthesizer circuit in accordance with said clock frequency setup information and on the basis of a reference frequency signal source having a frequency of fₛ, alternate between said M and adjacent value M′, control M and M′ changeover timing to vary the time ratio α for selecting the value M, alternate between said N and adjacent value N′, control N and N′ changeover timing to determine the time ratio β for selecting the value N, and set the frequency of the clock signal to be generated by said frequency synthesizer circuit to f₀=fₛ·{M·α+M′·(1−α)}/{N·β+N′·(1−β)}.

22. The information recording apparatus according to claim 16, 17, 18, 19, 20, or 21, wherein the cut-off frequency f_{LPF} of a low-pass filter for reducing the high-frequency components of a frequency control signal that controls a variable frequency oscillator for use in a frequency synthesizer circuit, which is a part of said clock generation means, is lower than a changeover frequency f_{SW} for changing said value M or said value N.

23. The information recording apparatus according to claim 12, wherein said address information error detection means uses the cyclic redundancy code detection result concerning said reproduction address information, and when said cyclic redundancy code detection result is correct, judges that said reproduction address information is correct.

24. The information recording apparatus according to claim 12, wherein said address information error detection means uses the address information continuity detection result, which indicates whether said reproduction address information is continuous, and when said address information continuity detection result indicates address continuity, judges that said reproduction address information is correct.

25. The information recording apparatus according to claim 8, wherein the amount of energy to be incident on an information recording medium for erasing information recorded on the information recording medium varies in synchronism with a setting update of said recording system clock frequency.

26. The information recording apparatus according to claim 8, wherein the amount of energy to be incident on an information recording medium for reproducing address information recorded on the information recording medium varies in synchronism with a setting update of said recording system clock frequency.

27. The information recording apparatus according to claim 8, wherein the sample-and-hold pulse timing for sampling and holding at least one of a focus servo signal, a tracking servo signal, a laser emission light amount signal, and a wobble signal varies in synchronism with a setting update of said recording system clock frequency.

28. The information recording apparatus according to claim 8, further comprising recording operation stop detection means for detecting a stopped recording operation and outputting a recording operation stop signal, wherein, when a recording operation is to be stopped, the recording operation stop signal inhibits a recording system clock frequency setting from being updated.

29. The information recording apparatus according to claim 8, wherein the data recording position information to be output from said recording position detection means and the clock frequency setup information to be output from said clock frequency calculation means are both output in compliance with an update timing instruction based on said clock frequency update timing information.

30. The information recording apparatus according to claim 17, 18, 19, 20 or 21, the time for switching from the value M or N to an adjacent value is in synchronism with the time for count value loading by a programmable counter for a frequency divider, which composes said frequency synthesizer.

31. The information recording apparatus according to claim 8, wherein said clock generation means is configured to generate a recording system clock frequency at a frequency resolution of ±0.5% or less and with a deviation of not more than ±1% from a target recording system clock frequency.
